(19) United States
(12) Patent Application Publication
(10) Pub. No.: US 2020/0126101 A1
(43) Pub. Date: Apr. 23, 2020

(54) INCORPORATE MARKET TENDENCY FOR RESIDUAL VALUE ANALYSIS AND FORECASTING

(71) Applicant: INTERNATIONAL BUSINESS MACHINES CORPORATION, Armonk, NY (US)

(72) Inventors: Changhua Sun, Beijing (CN); Zhi Hu Wang, Beijing (CN); Shiwan Zhao, Beijing (CN); Zhong Su, Beijing (CN)

(21) Appl. No.: 16/165,599

(22) Filed: Oct. 19, 2018

(51) Int. Cl. G06Q 30/02; G06N 5/02

(52) U.S. Cl. CPC G06Q 30/0206; G06N 5/02

(57) ABSTRACT

A computer-implemented method, a computer program product, and a computer processing system are provided for residual value prediction of an item. The method includes predicting, by a processor device, features of the item from unstructured data and structured data. The method further includes predicting, by the processor device, a residual value of the item using the predicted features. The method also includes generating, by the processor device on an interactive user display device, an interactive display interface that includes a prediction of the residual value of the item and provides a set of user selectable actions for performing relative to the prediction.

### BACKGROUND

### Technical Field

The present invention generally relates to market analysis and prediction, and more particularly to incorporating market tendency for residual value analysis and forecasting.

### Description of the Related Art

Residual value analysis and forecasting for items such as, but not limited to, used cars and mobile phone, is an existing problem. Traditionally, structural data has been used such as that found in a secondhand price database, where such structural data includes transaction data of the residual value, features of the product like age, color, quality, brand, and so forth. However, it is still very challenging to analyze and forecast the residual value. Hence, there is a need for an improved approach to residual value analysis and forecasting.

### SUMMARY

According to an aspect of the present invention, a computer-implemented method is provided for residual value prediction of an item. The method includes predicting, by a processor device, features of the item from unstructured data and structured data. The method further includes predicting, by the processor device, a residual value of the item using the predicted features. The method also includes generating, by the processor device on an interactive user display device, an interactive display interface that includes a prediction of the residual value of the item and provides a set of user selectable actions for performing relative to the prediction.

According to another aspect of the present invention, a computer program product is provided for residual value prediction of an item. The computer program product includes a non-transitory computer readable storage medium having program instructions embodied therewith. The program instructions are executable by a computer to cause the computer to perform a method. The method includes predicting, by a processor device of the computer, features of the item from unstructured data and structured data. The method further includes predicting, by the processor device, a residual value of the item using the predicted features. The method also includes generating, by the processor device on an interactive user display device of the computer, an interactive display interface that includes a prediction of the residual value of the item and provides a set of user selectable actions for performing relative to the prediction.

According to yet another aspect of the present invention, a computer processing system is provided for residual value prediction of an item. The computer processing system includes an inactive display device. The computer processing system further includes a memory for storing program code. The computer processing system also includes a processor device for running the program code to predict features of the item from unstructured data and structured data. The processor further runs the program code to predict a residual value of the item using the predicted features. The processor also runs the program code to generate, on the interactive user display device, an interactive display interface that includes a prediction of the residual value of the item and provides a set of user selectable actions for performing relative to the prediction.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing an exemplary processing system to which the present invention may be applied, in accordance with an embodiment of the present invention;

FIG. 2 is a flow diagram showing an exemplary method for residual value analysis and forecasting using market tendency, in accordance with an embodiment of the present invention;

FIG. 3 is a flow diagram further showing a block of the method of FIG. 2, in accordance with an embodiment of the present invention;

FIG. 4 is a flow diagram further showing another block of the method of FIG. 2, in accordance with an embodiment of the present invention;

FIG. 5 is a flow diagram further showing yet another block of the method of FIG. 2, in accordance with an embodiment of the present invention;

FIG. 6 is a flow diagram further showing still another block of the method of FIG. 2, in accordance with an embodiment of the present invention;

FIG. 7 is a block diagram showing an illustrative cloud computing environment having one or more cloud computing nodes with which local computing devices used by cloud consumers communicate, in accordance with an embodiment of the present invention; and

FIG. 8 is a block diagram showing a set of functional abstraction layers provided by a cloud computing environment, in accordance with an embodiment of the present invention.

### DETAILED DESCRIPTION

The present invention is directed to incorporating market tendency for residual value analysis and forecasting.

Residual value, such as that relating to used cars and mobile phones as examples, depends on the items' features and is also related to the historical value of similar products. However, this is actually a demand and market problem, and many other factors will also influence the value. Taking a mobile phone as an example, if a new model from the same manufacturer is coming to market, even a new version of an old model phone will be discounted, which will also impact the residual value of a used old model phone. Hence, as an example, if a new model 10 phone is recently released for sale, then even the price of an new model 8 will be discounted, which will impact the residual value of a used model 7 phone.

In consideration of the preceding, in an embodiment, the present invention incorporates market tendency for residual value analysis and forecasting, including: (1) incorporating the market time of the new model product of the same manufacturer; (2) incorporating the market tendency from social media, news, and discussion.

In various embodiments, a system and method are provided to forecast residual value for used car in the future, the system can alert the residual value and give recommendation for the sale time. In an embodiment, an implementation of the present invention can involve the following two steps:
(i) Predict important features in the future from unstructured and structured data;
(ii) Predict the residual value of the used car in the future using the predicted features

Hence, various embodiments of the present invention can use unstructured and structured data.

As used herein, the term “structured data” refers to data that has been organized into a formatted repository, typically a database, so that its elements can be made addressable for more effective processing and analysis. A data structure is a kind of repository that organizes information for that purpose.

Also, as used herein, the term “unstructured data” refers to essentially everything else. Unstructured data has internal structure but is not structured via pre-defined data models or schema. It may be textual or non-textual, and human- or machine-generated. It may also be stored within a non-relational database such as, but not limited to, NoSQL.

It is to be appreciated that the present invention can be used to predict the residual value of an item, where that item can essentially be any type of item that can have a residual value remaining after its initial purchase. For example, the item can be, but is not limited to, a smart phone, a user motor vehicle (car, motorcycle, motorhome, etc.), appliances, electronics, electronic games, and so forth. It is to be appreciated that the preceding items are merely illustrative and thus the present invention can be applied to these and other types of items while maintaining the spirit of the present invention.

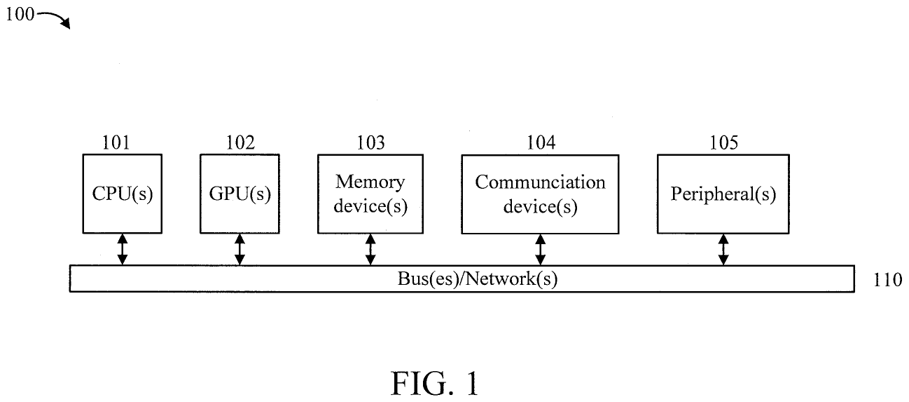

FIG. 1 is a block diagram showing an exemplary processing system 100 to which the present invention may be applied, in accordance with an embodiment of the present invention. The processing system 100 includes a set of processing units (e.g., CPUs) 101, a set of GPUs 102, a set of memory devices 103, a set of communication devices 104, and set of peripherals 105. The CPUs 101 can be single or multi-core CPUs. The GPUs 102 can be single or multi-core GPUs. The one or more memory devices 103 can include caches, RAMs, ROMs, and other memories (flash, optical, magnetic, etc.). The communication devices 104 can include wireless and/or wired communication devices (e.g., network (e.g., WIFI, etc.) adapters, etc.). The peripherals 105 can include a display device, a user input device, a printer, an imaging device, and so forth. Elements of processing system 100 are connected by one or more buses or networks (collectively denoted by the figure reference numeral 110).

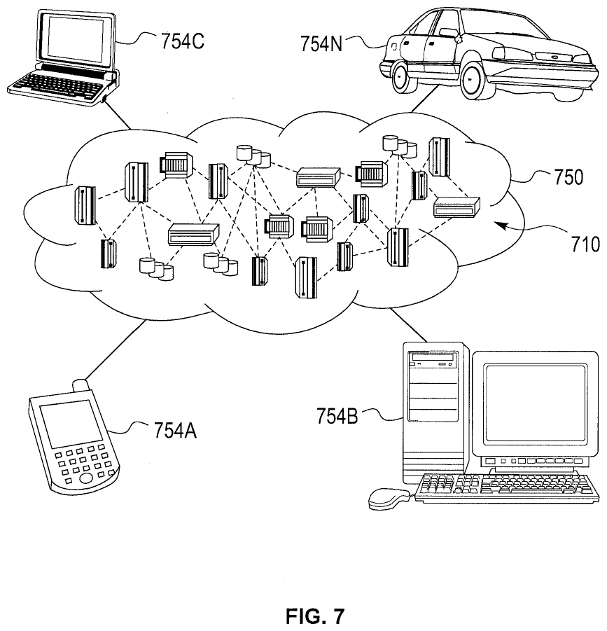

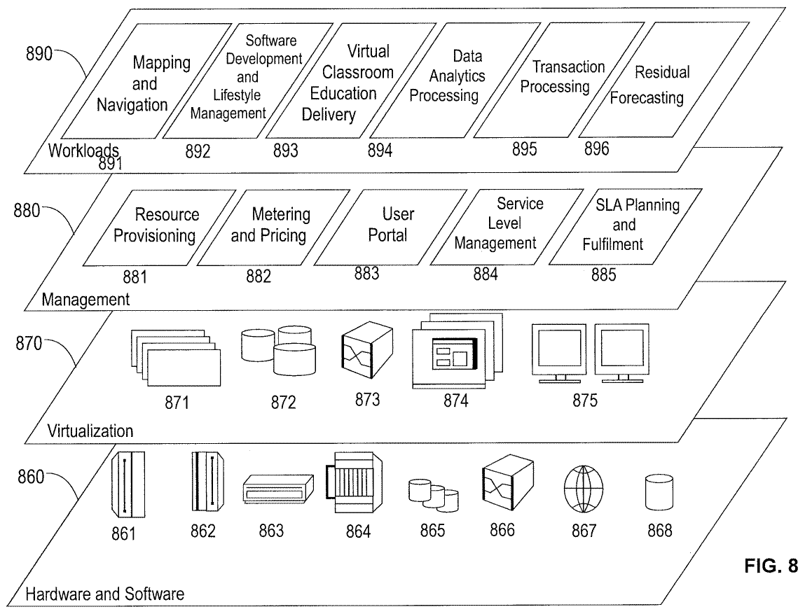

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. Further, in another embodiment, a cloud configuration can be used (e.g., see FIGS. 7-8). These and other variations of the processing system 100 are readily contemplated by one of ordinary skill in the art given the teachings of the present invention provided herein.

Moreover, it is to be appreciated that various figures as described below with respect to various elements and steps relating to the present invention that may be implemented, in whole or in part, by one or more of the elements of system 100.

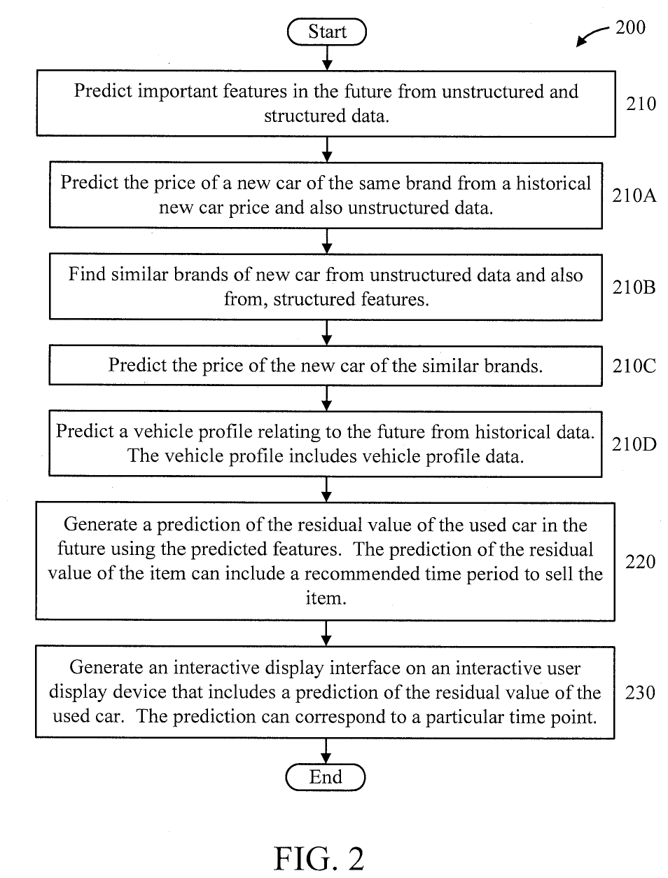

FIG. 2 is a flow diagram showing an exemplary method 200 for residual value analysis and forecasting using market tendency, in accordance with an embodiment of the present invention.

In an embodiment, method 200 is used to forecast a residual value for a used car in the future, where the method can alert a user of the residual value and provide a recommendation for sale time.

At block 210, predict important features in the future from unstructured and structured data. In an embodiment, block 210 can involve one or more of predicting the price of a new car of the same brand (block 210A), finding similar brands of new car (block 210B), predicting the price of new cars of similar brands (210C), and predicting a vehicle profile (210D). Accordingly, the important features can be considered to be one or more of the new car price (block 210A), the similar brands of new car (block 210B), the predicted price of new cars of similar brands (210C), and the predicted vehicle profile (210D).

In an embodiment, block 210 can include one or more of blocks 210A through 210D.

At block 210A, predict the price of a new car of the same brand from a historical new car price and also unstructured data. The unstructured data can include, for example, but is not limited to, pre-release news of new car and/or so forth. It is to be appreciated that the present invention is not limited to solely the preceding unstructured data and thus other unstructured data can also be used, as readily appreciated by one of ordinary skill in the art given the teachings of the present invention provided herein, while maintaining the spirit of the present invention.

At block 210B, find similar brands of new car from unstructured data and also from, structured features. The unstructured data can include, for example, but is not limited to, discussions, comparison or evaluation news, and/or so forth. The structured features can include, for example, but is not limited to, car type, size, price, sales volume, and/or so forth. It is to be appreciated that the present invention is not limited to solely the preceding unstructured data and structured features and thus other unstructured data and structure features can also be used, as readily appreciated by one of ordinary skill in the art given the teachings of the present invention provided herein, while maintaining the spirit of the present invention.

At block 210C, predict the price of the new car of the similar brands.

At block 210D, predict a vehicle profile relating to the future from historical data. The vehicle profile includes vehicle profile data. The vehicle profile data can include, for example, but is not limited to, driving miles, driving habit, and/or so forth. It is to be appreciated that the present invention is not limited to solely the preceding vehicle profile data and thus other vehicle profile data can also be used, as readily appreciated by one of ordinary skill in the art given the teachings of the present invention provided herein, while maintaining the spirit of the present invention.

At block 220, generate a prediction of the residual value of the used car in the future using the predicted features. In an embodiment, the prediction of the residual value of the item can include a recommended time period to sell the item.

At block 230, generate an interactive display interface on an interactive user display device (e.g., a touchscreen display) that includes a prediction of the residual value of the used car. The prediction can be for a particular time point (e.g., in the future). The interactive display interface can allow a user to perform a myriad of functions relating to the prediction. In an embodiment, the interactive display interface can provide a set of user selectable actions for performing relative to the prediction. For example, the interactive display interface can allow a user to modify the value (with or without adding justifying data for the modification), justify the specified value with supplemental data, commence an auction using the prediction as a minimum amount (i.e., reserve), and so forth. It is to be appreciated that the preceding actions are merely illustrative and thus these and other actions can be performed relative to the prediction, as readily appreciated by one of ordinary skill in the art given the teachings of the present invention provided herein, while maintaining the spirit of the present invention.

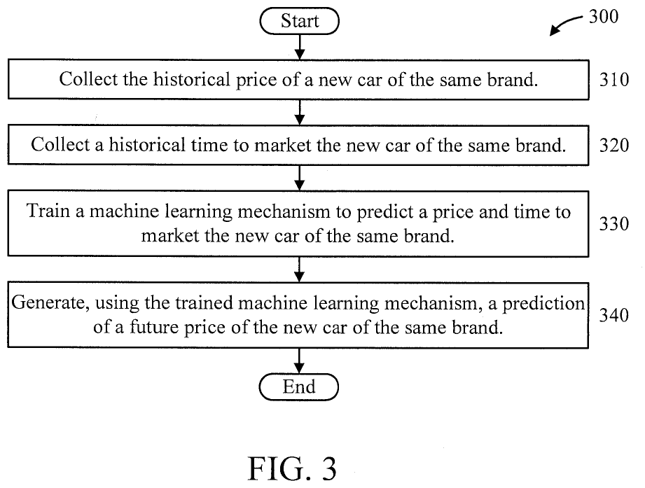

FIG. 3 is a flow diagram further showing block 210A of the method 200 of FIG. 2, in accordance with an embodiment of the present invention.

At block 310, collect the historical price of a new car of the same brand.

At block 320, collect a historical time to market the new car of the same brand.

At block 330, train a machine learning mechanism to predict a price and time to market the new car of the same brand.

At block 340, generate, using the trained machine learning mechanism, a prediction of a future price of the new car of the same brand.

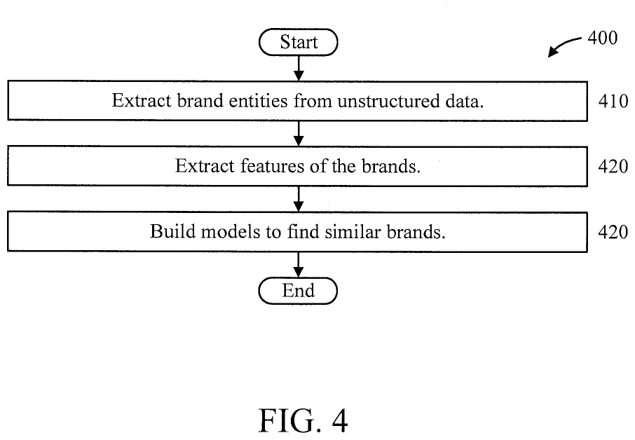

FIG. 4 is a flow diagram further showing block 210B of the method 200 of FIG. 2, in accordance with an embodiment of the present invention.

At block 410, extract brand entities from unstructured data.

At block 420, extract features of the brands. The features can include, for example, but are not limited to, number of seats, car size, price, sales volume, and so forth. It is to be appreciated that the present invention is not limited to solely the preceding features and thus other features can also be used, as readily appreciated by one of ordinary skill in the art given the teachings of the present invention provided herein, while maintaining the spirit of the present invention.

At block 430, build models to find similar brands.

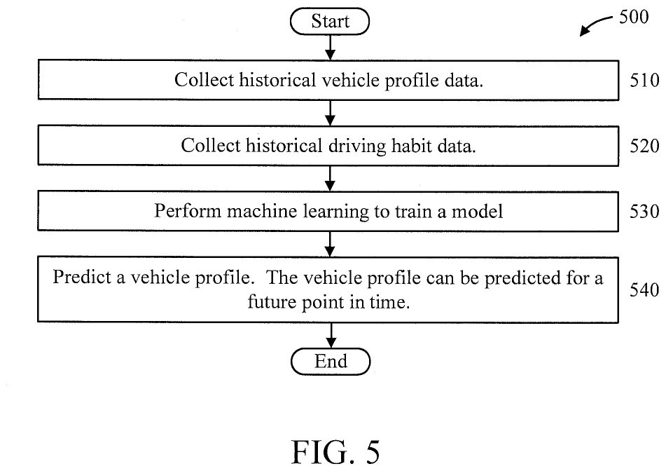

FIG. 5 is a flow diagram further showing block 210D of the method 200 of FIG. 2, in accordance with an embodiment of the present invention.

At block 510, collect historical vehicle profile data. The historical vehicle profile data can include, for example, but is not limited to, miles per month, speed, maintenance, accident history, brand, model, new car price, transmission type, color, emission level, new car registration date, and/or so forth. It is to be appreciated that the present invention is not limited to solely the preceding historical vehicle profile data and thus other historical vehicle profile data can also be used, as readily appreciated by one of ordinary skill in the art given the teachings of the present invention provided herein, while maintaining the spirit of the present invention.

At block 520, collect historical driving habit data. The historical driving habit data can include, for example, but is not limited to, always stepping on the brakes (even in the absence of obstacles), driving fast, and so forth. It is to be appreciated that the present invention is not limited to solely the preceding historical driving habit data and thus other historical driving habit data can also be used, as readily appreciated by one of ordinary skill in the art given the teachings of the present invention provided herein, while maintaining the spirit of the present invention.

At block 530, perform machine learning to train a model (e.g., the model(s) built per block 430 of FIG. 4).

At block 540, predict a vehicle profile. In an embodiment, the vehicle profile can be predicted for a future point in time.

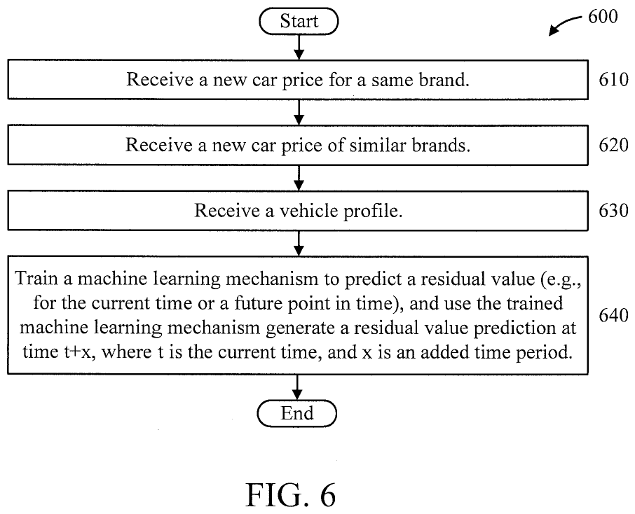

FIG. 6 is a flow diagram further showing block 220 of the method 200 of FIG. 2, in accordance with an embodiment of the present invention.

At block 610, receive a new car price for a same brand.

At block 620, receive a new car price of similar brands.

At block 630, receive a vehicle profile.

At block 640, train a machine learning mechanism to predict a residual value (e.g., for the current time or a future point in time), and use the trained machine learning mechanism generate a residual value prediction at time t+x, where t is the current time, and x is an added time period.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 750 is depicted. As shown, cloud computing environment 750 includes one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

Referring now to FIG. 8, a set of functional abstraction layers provided by cloud computing environment 750 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; virtual classroom education delivery 893; data analytics processing 894; transaction processing 895; and residual forecasting incorporating market tendency 896.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for residual value prediction of an item, comprising:
predicting, by a processor device, features of the item from unstructured data and structured data;
predicting, by the processor device, a residual value of the item using the predicted features; and
generating, by the processor device on an interactive user display device, an interactive display interface that includes a prediction of the residual value of the item and provides a set of user selectable actions for performing relative to the prediction.

2. The computer-implemented method of claim 1, wherein the step of predicting the features comprises:
predicting, as one of the features, a price of a new item of the same brand from a historical new item price and unstructured data;
finding, as another one of the features, similar brands to a new version of the item from unstructured data and structured features.
predicting, as yet another one of the features, a price of a new item of similar brands; and
predicting, as still another one of the features, a vehicle profile from at least historical data.

3. The computer-implemented method of claim 2, wherein the unstructured data from which the price of the new item of the same brand is predicted comprises news release of a new version of the item.

4. The computer-implemented method of claim 2, wherein the unstructured data from which the similar brands are found comprises one or more objects selected from the group consisting of discussions, comparisons, and evaluations.

5. The computer-implemented method of claim 2, wherein the item is a motor vehicle, and the structured features comprise one or more objects selected from the group consisting of a motor vehicle type, a motor vehicle size, and a motor vehicle price sales volume.

6. The computer-implemented method of claim 2, wherein the item is a motor vehicle, and the historical data from which the vehicle profile is predicted comprises one or more items selected from the group consisting of driving miles and driving habits.

7. The computer-implemented method of claim 2, wherein the item is a motor vehicle, and the vehicle profile is predicted from data comprising one or more items selected from the group consisting of brand, model, new car price, transmission type, color, emission level, and new car registration date.

8. The computer-implemented method of claim 1, wherein the set of user selectable actions comprise modifying the prediction of the residual value of the item with justification data and modifying the prediction of the residual value of the item without the justification data.

9. The computer-implemented method of claim 1, wherein the set of user selectable actions comprise commencing an auction using the prediction as a reserve for the auction.

10. The computer-implemented method of claim 1, wherein the prediction of the residual value of the item comprises a recommended time period to sell the item.

11. A computer program product for residual value prediction of an item, the computer program product comprising a non-transitory computer readable storage medium having program instructions embodied therewith, the program instructions executable by a computer to cause the computer to perform a method comprising:
predicting, by a processor device of the computer, features of the item from unstructured data and structured data;
predicting, by the processor device, a residual value of the item using the predicted features; and
generating, by the processor device on an interactive user display device of the computer, an interactive display interface that includes a prediction of the residual value of the item and provides a set of user selectable actions for performing relative to the prediction.

12. The computer program product of claim 11, wherein the step of predicting the features comprises:
predicting, as one of the features, a price of a new item of the same brand from a historical new item price and unstructured data;
finding, as another one of the features, similar brands to a new version of the item from unstructured data and structured features.
predicting, as yet another one of the features, a price of a new item of similar brands; and
predicting, as still another one of the features, a vehicle profile from at least historical data.

13. The computer program product of claim 12, wherein the unstructured data from which the price of the new item of the same brand is predicted comprises news release of a new version of the item.

14. The computer program product of claim 12, wherein the unstructured data from which the similar brands are found comprises one or more objects selected from the group consisting of discussions, comparisons, and evaluations.

15. The computer program product of claim 12, wherein the item is a motor vehicle, and the structured features comprise one or more objects selected from the group consisting of a motor vehicle type, a motor vehicle size, and a motor vehicle price sales volume.

16. The computer program product of claim 12, wherein the item is a motor vehicle, and the vehicle profile is predicted from data comprising one or more items selected from the group consisting of brand, model, new car price, transmission type, color, emission level, and new car registration date.

17. The computer program product of claim 11, wherein the set of user selectable actions comprise modifying the prediction of the residual value of the item with justification data and modifying the prediction of the residual value of the item without the justification data.

18. The computer program product of claim 11, wherein the set of user selectable actions comprise commencing an auction using the prediction as a reserve for the auction.

19. The computer program product of claim 11, wherein the prediction of the residual value of the item comprises a recommended time period to sell the item.

20. A computer processing system for residual value prediction of an item, comprising:
an inactive display device;
a memory for storing program code; and
a processor device for running the program code to
predict features of the item from unstructured data and structured data;
predict a residual value of the item using the predicted features; and
generate, on the interactive user display device, an interactive display interface that includes a prediction of the residual value of the item and provides a set of user selectable actions for performing relative to the prediction.
